(19) United States
(12) Patent Application Publication
(10) Pub. No.: US 2007/0065618 A1
(43) Pub. Date: Mar. 22, 2007

(54) Decorative article, kit and method employing the same

(76) Inventors: Christopher E. Fischer, Boulder, CO (US); Jessica L. Fischer, Boulder, CO (US)

Correspondence Address: MARTIN & HENSON, P.C., 9250 W 5TH AVENUE, SUITE 200, LAKEWOOD, CO, 80226, US

(21) Appl. No.: 11/234,053

(22) Filed: Sep. 22, 2005

(51) Int. Cl. B32B 33/00

(52) U.S. Cl. 428/40.1

(57) ABSTRACT

A decorative article is formed by a front sheet of a first material, a layer of tacky material secured thereto to create a decorative panel, and a removable backing sheet. The panel has a peripheral edge that conveys an outline of an image. The front sheet has a surface with graphics correlated to the outline. In a disclosed embodiment, some graphic elements can be an extension of portions of the outline. A kit including a plurality of such decorative panels correlated to a common theme is also disclosed with the decorative panels being pre-printed or colorable by the user. In the latter case, the kit includes markers of different colors. A method of decorating a wall is also disclosed wherein a plurality of theme correlated decorative panels are adhered to the wall by the tacky material.

### BACKGROUND OF THE DISCLOSURE

Throughout history, humans have sought to enhance the aesthetics of their surroundings by the use of decorative items. Such items have included such diverse elements as wall paintings, tiles, tapestries and two-dimensional art, to name a few. In many instances, such decorative elements become a relatively permanent part of the environment in which they are placed, remaining on display for years on end. In contrast to these long-term decorations, some decorative items are intended to be of a more transient nature.

Surfaces of these surroundings may be formed with or have applied thereto a variety of different inlays or coverings and the like. For example, horizontal floor surfaces may be formed by decorative mosaic tiles or may be covered with rugs of varied colors and patterns. Ceiling surfaces are known to be painted, and it is known that ceilings can be painted with elaborate artwork. Vertical wall surfaces may be covered with paint, wallpaper and the like, and artwork may be hung from such vertical surfaces. Vertical surfaces may also be decorated by cloth hangings, such as tapestries or other cloth materials. Junctions between vertical and horizontal surfaces are sometimes decorated with elaborate moldings, and objects of art may be placed throughout the volume created to further enhance the environment.

Temporary decorations, on the other hand, are desirable in order that the decorative theme be readily changed. For example, the decorations in a child's room may be changed as the child matures and has rapidly changing interests. Another example is the changing of decorative themes for holidays and festive occasions.

Placing temporary decorations on the vertical walls of a room, though, is heretofore not without its disadvantages. Since the weight of the decorative panel must be supported by the vertical surface, such panels are often adhered to the walls by tape, more permanent adhesives or suspension hangers. Where tape is used, its presence can detract from the aesthetic appearance if exposed. In any event, removal of the adhesive material often damages the wall or the paint thereon. Suspension hangers, on the other hand, require attachment of a mechanism to the wall either by nails, screws, adhesives or other attachment means. This again perfectly damages the wall surface requiring repair.

In an effort to avoid this problem, some tacky adhesives have been developed in the form of putty-like materials, but such material tend to harden and lose their adhesiveness over a period of time. In addition, these putty-like materials sometimes lack the adhesive strength to support all but the lightest of articles. After time, these materials may react with coatings on the surface so that their removal may damage the wall surface.

Accordingly, there is a need for articles of manufacture that can secure to vertical wall surfaces, ceilings, floors, doors, windows and the like in order to provide decoration therefor and which articles may be easily rearranged, interchanged and/or replaced. There is yet another need for such articles to be of such nature as to not damage the wall surface in any way upon removal. There is a further need for kits employing such articles either to allow a “do-it-yourselfer” or to allow children to interact with the decoration of their surroundings. There is still a further need for improved methods of decorating wall surfaces.

### SUMMARY OF THE DISCLOSURE

According to one aspect of the present invention, new and useful articles or manufacture are provided which can be used to decorate vertical wall surfaces.

According to another aspect of the present invention, decorative articles are provided which are easily arranged, interchanged, and/or replaced.

It is another aspect of the embodiments of this invention to provide decorative articles that can mount on a vertical wall surface without damaging that wall surface upon removal.

An aspect of some of the disposed embodiments is the provision of a kit which can be used to create a correlated decorative theme for a living space.

Still a further aspect of some of the embodiments of the present invention is to provide articles that may be modified by the user in order to decorate his/her surroundings.

A still further aspect of this disclosure is to provide improved methods of decorating wall surfaces.

Decorative articles according to the present invention are adapted to be placed on a support surface. In their broad form, the decorative articles in some exemplary embodiments include a front sheet formed of a first material. A layer of tacky material is secured to the front sheet thereby to create a decorative panel. This decorative panel has a peripheral edge shaped to convey an outline of a selective decorative image to an observer. The front sheet thus has an exposed surface that includes graphics disposed thereon that are correlated to the decorative image formed by the outline of the decorative panel. The tacky material is selected so as to have sufficient adhering capability to support the weight of the decorative panel when the decorative panel is placed on a vertically disposed support surface yet not damage the wall coating upon removal. A backing sheet may be provided with this backing sheet removably secured to the layer of tacky material on a side thereof opposite the front sheet.

The tacky material used in these embodiments may be a thermal plastic elastomer such as a micropore copolymer. The front sheet should accept graphics printed by an ink printing process and may be selected from a group consisting of flocking, woven fabric, vinyl and paper. The backing sheet may be selected from a group consisting of paper and plastic.

In several embodiments, the graphics are such that at least one or more graphic elements appears as an extension of the outline of the decorative panel onto the exposed surface of the front sheet. The decorative image may be selected from a group consisting of real animals, imaginary animals, cartoon characters, logos, celestial bodies and symbols.

The disclosed embodiments of the present invention may also be used to form a kit adapted for use in decorating surfaces. Here, a plurality of separate decorative panels are each correlated to a selected common decorative theme. Each of the decorative panels includes a front sheet formed of a first material and a layer of tacky material secured to the front sheet. At least one of the decorative panels has a peripheral edge shaped to convey to an observer an outline of a selected decorative image corresponding to the common decorative theme with graphics disposed thereon that are correlated to the decorative image formed by the outline of the decorative panel. Moreover, at least some of the decorative panels in the kit include graphics disposed thereon that are correlated to the common decorative theme. Again, the tacky material has sufficient adhering capability to support the weight of the decorative panel when the decorative panel was placed on a vertically disposed support surface.

In this kit, a plurality of the decorative panels can each have a peripheral edge shaped to convey to an observer an outline of a selected decorative image corresponding to the common decorative theme and each has graphics disposed thereon that are correlated to the decorative image formed by the outline of the respective decorative panel. It is contemplated that all of the decorative panels can include graphics disposed thereon that are correlated to the common decorative theme.

In the kit embodiment, the tacky material may again be a thermoplastic elastomer such as a micropore polymer. The front sheet can again be flocking, woven fabric, vinyl and paper. Moreover, at least one of the decorative panels includes one graphic element that appears as an extension of the outline of the decorative panel on the exposed surface of the respective front sheet. The decorative images again can be selected from a group consisting of real animals, imaginary animals, cartoon characters, logos, celestial bodies and symbols.

In another embodiment, a kit is provided wherein a plurality of separate decorative panels are provided. Here, each of the decorative panels includes a front sheet formed of a first material with the front sheet of each decorative panel having graphics disposed thereon that are operative to convey boundaries of portions of a respective decorative image to an observer with exposed areas demarked by the boundaries. A layer of tacky material is secured to the front sheet. This kit then includes a plurality of markers of different colors. Each of these markers include a colored substance capable of being applied to the front sheets within the exposed areas so that a user may selectively color the exposed areas with such colored substances thereby to complete the respective decorative image. A container is then provided that is sized and adapted to receive the plurality of decorative panels and the plurality of markers.

The embodiments of the present invention contemplate a method of decorating a room having a wall with a wall surface. This method can employ any of the steps inherent in the described embodiments. In this broad form, the method includes the step of providing a plurality of separate decorative panels each correlated to a selected common decorative theme. Here, again, the decorative panels each include a front sheet formed of a first material and a layer of tacky material secured to the front sheet. At least one of the decorative panels has a peripheral edge shaped to convey to an observer and outline of a selected decorative image corresponding to a common decorative theme. Graphics are disposed on such decorative panel with the graphics correlated to the decorative image formed by the outline of the decorative panel. At least some of the decorative panels can include graphics disposed thereon that are correlated to the common decorative theme. The tacky material can again be selected to have sufficient adhering capability to support the weight of the respective decorative panel when the decorative panel is placed on the wall yet which is releasable from the wall without damaging the wall surface. The method then includes the step of adhering the decorative panels onto the wall by means of the tacky material thereby to cover selected areas of the wall.

These and other aspect of the exemplary embodiments of the present invention will become more readily appreciated and understood from a consideration of the following detailed description taken together with the accompanying drawings, in which:

### BRIEF DESCRIPTION OF THE DRAWINGS

FIG. 1 is a front view in elevation showing a representative wall in a child's bedroom decorated using decorative articles according to different embodiments of the present invention, some of which are correlated to a common decorative theme;

FIG. 2 is a front plan view of the outline of a decorative panel according to a first exemplary embodiment of the present invention illustrated without the graphics thereon;

FIG. 3 is front view in elevation of the decorative panel of FIG. 2 including graphics according to the present invention;

FIG. 4 is an end view in elevation showing the layered structure of the decorative panel of FIGS. 2 and 3;

FIG. 5 is an exploded end view in elevation showing the decorative panels of FIGS. 2-4;

FIG. 6 is a front view in elevation of a second exemplary embodiment of the present invention without the graphics thereon;

FIG. 7 is a front view in elevation of the decorative panel of FIG. 6 including graphics thereon;

FIG. 8 is a front view in elevation of a third exemplary embodiment of a decorative panel illustrating the present invention without the graphics thereon;

FIG. 9 is a front view in elevation of the decorative panel of FIG. 8 with the graphics thereon;

FIG. 10 is a front view in elevation of yet another exemplary embodiment of a decorative panel without the graphics thereon;

FIG. 11 is a front view in elevation of the decorative panel of FIG. 10 with the graphics formed thereon;

FIG. 12 is another exemplary embodiment of a decorative panel according to the present invention; and

FIG. 13 is a diagrammatic view of an exemplary embodiment of a kit according to the present invention.

### DETAILED DESCRIPTION OF THE EXEMPLARY EMBODIMENTS

The present invention broadly relates to decorative articles, kits and methods that may be used to decorate a surface in an easy, convenient manner. Such decorative articles can take a variety of forms and can either be completely finished and “ready to use” or can optionally involve artistic input from the user. In any event, the decorative articles according to the exemplary embodiments of the present invention, as well as the method and kit incorporating the same, involve the use of decorative panels which are self adhering to most surfaces but which can be readily removed without damage to such surface.

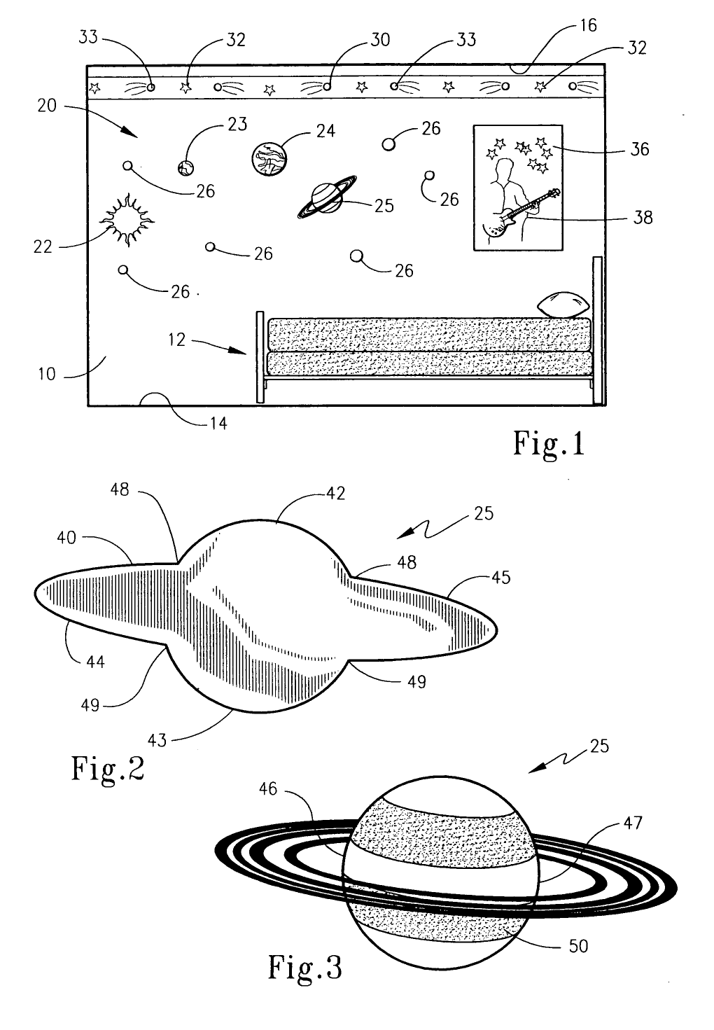

In order to introduce the decorative articles, methods and kits according to the present invention, FIG. 1 illustrates a vertical wall surface 10 of a child's room wherein a bed 12 rests on a floor 14 with an opposite ceiling 16. In this illustration, a total of twelve decorative articles are shown, but by no means is the invention to include any such specific number. Here, however, these twelve decorative articles are in the form of a representative solar system 20 (ten pieces), a border panel 30 and a poster panel 36.

Solar system 20 is formed by a “sun” panel 22 an earth panel 23 a “Jupiter” panel 24 a “Saturn” panel 25 and additional panels 26 representing the remaining planets of the solar system. Border panel 30, on the other hand, is an elongated strip disposed on wall surface 10 parallel and proximate to ceiling 16. Border panel 30 has graphics thereon that is here illustrated as enlarged stars 32 and comet images 33. Accordingly, the decorative images in the form of stars 32 and comets 33 are correlated to the decorative theme of the solar system 20. Poster 36, on the other hand, is a rectangular panel that may have, for example, the decorative image of a musical performer 38 illustrated thereon. It should be understood, however, that the exact nature of the decorative theme and the decorative images provided by the decorative articles is virtually unlimited.

In order to understand, in part, the structure of a representative exemplary embodiment of a decorative article according to the present invention, Saturn panel 25 is illustrated in greater detail in FIGS. 2 and 3. In these figures, the decorative panel 25 has a peripheral edge 40 shaped to convey an outline of a selected decorative image to an observer. Here, the peripheral edge 40 includes first arcuate portions 42 and 43 configured to form a two-dimensional appearance of the body of the planet “Saturn”. Second arcuate portions 44 and 45 are configured to form the outline of Saturn's rings and meet sith arcuate portions 42 and 43 at junctions 48 and 49.

With reference specifically to FIG. 3, it may be seen that graphics are disposed on panel 25 to complete the decorative image of the planet Saturn. As may be appreciated, some of the graphics illustrated in FIG. 3 are specifically correlated with and thus interact with the peripheral edge 40 in forming the decorative image. Here, for example, arcuate lines 46 and 47 are formed as extensions of arcuate edge portion 42 extending from junctions 48 (FIG. 2) as extension of the spherical body of the planet Saturn. Arcuate line 50 extends between junctions 49 as a continuation of arcuate portions 44 and 45 to provide the completion of the peripheral edge forming the rings of Saturn that pass in front of the planetary body. The remaining graphics on panel 25 are correlated to the decorative image of Saturn by completing the appearance of the body and rings of Saturn as may be seen through a telescope.

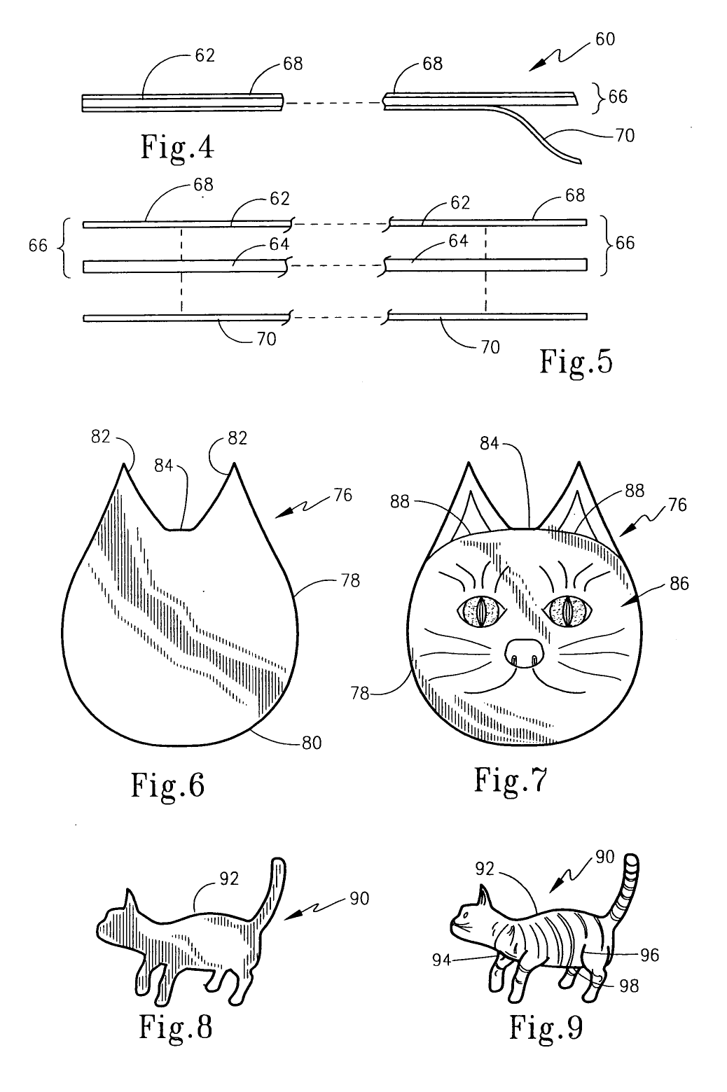

FIGS. 4 and 5 are provided to illustrate the construction of a representative decorative panel 60. Here it may be seen that decorative article 60 is formed by a front sheet 62 of a first material. A layer 64 of tacky material is secured to the front sheet 62 thereby to create a decorative panel 66. Front sheet 62 has an exposed surface 68 that includes the graphics disposed thereon. A backing sheet 70 is removably secured to layer 64 opposite front sheet 62.

In this construction, it should be understood that the composition of the layer of tacky material 64 should be sufficient to support the weight of the decorative panel when placed on a vertical wall surface without detachment, but it should also be of a composition that will not damage paint, wallpaper or other surface coating of the wall surface when removed. Tacky material 64 may be any convenient thermal plastic elastomer, such as a micropore copolymer. Such micropore copolymores utilize surface tension technology and are of the type such as available from Haartz Corporation of Acton, Mass.

Front sheet 62 can be any suitable material to which the tacky layer may be bonded, such as a flocking, woven cloth or fabric, vinyl, or paper. Typically, the tacky layer 64 is mechanically bonded to the front sheet 62 by means of heat and pressure, as is known in the art. Due to temperature considerations, front sheet 62 should be able to withstand the heat (approximately 350° F.). The graphics may be applied to a formed article after assembly of the front sheet 62, tacky layer 64 and backing sheet 70. Since the graphics are applied to the front sheet, its composition should be such as to accept conventional ink printing processes, such as screen printing or digital printing. Taken into account with the need to withstand high temperatures, one especially suitable material is woven polyester. Backing sheet 70 may be selected from a group of paper and plastic. When constructed, the outline or peripheral margin of the decorative images may be die cut or platter cut, depending on selected manufacturing techniques.

A second exemplary embodiment of a decorative article is illustrated in FIGS. 6 and 7, and it should be understood that the fabrication of the decorative article is the same as that described with respect to FIGS. 4 and 5. In FIGS. 6 and 7, the decorative panel 76 has a peripheral edge 78 in the outline of the face of a cat. Peripheral edge 78 includes a partial circular portion 80, a pair of wedge shaped ear portions 82 and an arcuate portion 84 extending between ear portions 82, all is best shown in FIG. 6. Graphics 86 are formed on the exposed surface of decorative panel 76 to completed the “cat image”. Here, it may be seen that arcuate portions 88 are formed as an extension of the outline or peripheral edge of panel 76 so as to interconnect the ends of circular portion 78 and arcuate edge 84. Other graphic elements are provided to illustrate details of the cat's ears, the cat's eyes, nose and whiskers.

Likewise, a third exemplary embodiment is illustrated in FIGS. 8 and 9 as a kitten. Thus, as is shown in FIG. 8, panel 90 has a peripheral edge 92 in the outline of a cat. Graphics are again placed on the exposed surface of panel 90 and it may be seen that arcuate portions 94, 96 and 98 form extensions of the outline formed by peripheral edge 92. Further graphics are provided to complete the image of the kitten. A panel 76 and a plurality of panels 90 may be employed to create a feline decorative theme, for example and not limitation.

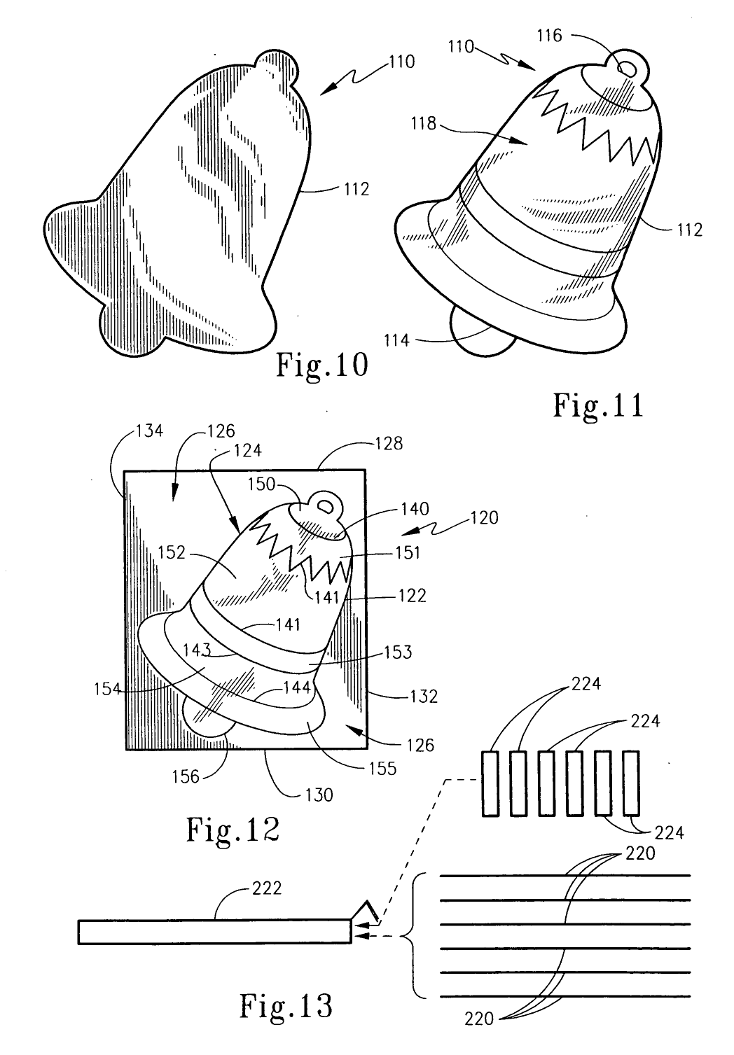

Turning now to FIGS. 10 and 11, yet another decorative article is illustrated, here in the form of a Christmas bell. Decorative panel 110 has a peripheral edge 112 outlining the bell shape. Graphics are provided and include portions, such as portions 114 and 116 which correlate to and complete the outline of the bell. Additional graphics 118 are provided internally of peripheral edge 112 to create the festive bell appearance.

With reference to the foregoing, it should be appreciated that the decorative article according to the present invention can have almost an unlimited variety of decorative images. For example, the decorative image can be selected from a group consisting of real animals, imaginary animals, cartoon and fictional characters, logos (such as college or professional sports teams), celestial bodies and symbols. By the word “symbols” it is meant that any notation that conveys an idea such as numbers, letters and words (in any language), mathematical notations, punctuation marks, musical notes, musical symbols (such as musical clefts), and the like are encompassed by the term.

Moreover, with reference to FIG. 1, it may be seen that the present invention contemplate the kits adapted for use in decorating surfaces. Here, the kit includes a plurality of separate decorative panels, such as panels 22-26 each correlated to a common decorative theme with each decorative panel being constructed as described above. Further, at least one of the decorative panels has a peripheral edge shaped to convey to an observer an outline of a selected decorative image corresponding to the common decorative theme such as Saturn panel 25. Graphics are disposed on such panel with the graphics being correlated to the decorative image formed by the outline of the decorative panel. Moreover, at least some of the decorative panels include graphics disposed thereon that are correlated to the common decorative theme. Here, for example, border panel 30 could be included as part of such kit with the graphics illustrated as star 32 and comets 33 correlated to the decorative theme.

With continued reference again to FIG. 1, it may be seen that other decorative articles, such as poster panel 36, may be created. Here, poster panel 36 is constructed as described above. The graphics placed on such panel, however, may be a single theme such as a musical performer 38. Thus, it is desirable that the front sheet of the decorative article be such as to accept any type of printed image to allow flexibility of the appearance of such decorative panel.

Turning now to FIG. 12, it may be appreciated that a decorative panel may also be created that allows interaction by the user in participating in the ultimate appearance of the decorative article. Thus, as is illustrated in FIG. 12, a decorative panel 120 includes graphics in the form of the bells such as a bell 122 similar to that shown in FIG. 11. Here, the bell has a peripheral edge 124 surrounded by margin portions 126 located between peripheral edge 124 and the edges 128, 130, 132 and 134 of panel 120. The graphics create boundaries, such as boundary lines 140-144 with exposed areas 150-156 being demarked by such boundary lines and the peripheral edge.

It is contemplated, then, that a user, such as a child, may apply a coloring agent, such as paint, crayon and the like, to the exposed front sheet of the decorative article to color in these exposed areas 150-156, as desired. The user may then, if desired, may apply the decorative panel 120 directly to the wall or, optionally, cut out the shape of the peripheral edge to remove the boundary areas 126 prior to application of the image to the wall. In the later case, once cut, portions of the graphics are correlated to and form an extension of the peripheral edge in the manner of that described with respect to FIG. 11. Further, if desired, it would be possible to perforate panel 120 along peripheral edge 124 so that boundary portions 126 could be removed without the need for cutting the image with scissors.

As is illustrated in FIG. 13, a plurality of separate decorative panels 220 constructed, as described with respect to FIG. 12, could be packaged in any suitable container 222 along with selected markers 224 of different colors so that a complete kit may be packaged allowing the user to color in the graphic images and subsequently display the panels on a vertical wall surface. Here, of course, the panels 220 each include a front sheet formed by a first material, as described above, and graphics disposed thereon that are operative to convey boundaries of portions of a respective decorative image to an observer with the exposed areas demarked by the boundaries. A layer of tacky material is secured to the boundaries of portions of the respective decorative image to an observer with exposed areas being demarked by the boundaries. A layer of tacky material is secured to each of the front sheets. However, here the backing sheet may optionally be eliminated or included as desired. The markers 224, of course, should be a colored substance capable of being applied to the material of the front sheets.

From the foregoing, it should also understood that the exemplary embodiments discussed herein contemplate a method of decorating a room that has a wall with a wall surface. Here, the method can include any step inherent in the exemplary embodiments. Broadly, the method includes a first step of providing a plurality of separate decorative panels each correlated to a selected common decorative theme wherein each of the decorative panels includes a front sheet formed of a first material and a layer of tacky material secured to the front sheet. According to this method, at least one of the decorative panels has a peripheral edge shaped to convey to an observer an outline of a selective decorative image corresponding to the common decorative theme with graphics disposed thereon that are correlated to the decorative image formed by the outline of the decorative panel. At least some of the decorative panels, according to this method, include graphics disposed thereon that are correlated to the common decorative theme. The tacky material for such panels is selected to have sufficient adhering capability to support the weight of the respective decorative panel when the decorative panel is placed on the wall yet which is releasable from the wall without damaging the wall surface. The method then includes the steps of adhering the decorative panels onto the wall by means of the tacky material thereby to cover selected wall areas.

Accordingly, the exemplary embodiments of the present invention have been described with some degree of particularity. It should be appreciated, though, that the modifications or changes may be made to the exemplary embodiments of the present invention without departing from the inventive concepts contained herein.

We claim:

1. A decorative article adapted to be placed on a support surface, comprising:
(A) a front sheet formed of a first material;
(B) a layer of tacky material secured to said front sheet thereby to create a decorative panel, said decorative panel having a peripheral edge shaped to convey an outline a selected decorative image to an observer with said front sheet having an exposed surface including graphics disposed thereon that are correlated to the decorative image formed by the outline of said decorative panel, said tacky material having sufficient adhering capability to support the weight of said decorative panel when said decorative panel is placed on a vertically disposed support surface; and
(C) a backing sheet removably secured to said layer of tacky material on a side thereof opposite said front sheet.

2. A decorative article according to claim 1 wherein the tacky material is a thermal plastic elastomer.

3. A decorative article according to claim 2 wherein the thermal plastic elastomer is a micropore copolymer.

4. A decorative article according to claim 1 wherein said front sheet is selected from a group consisting of: flocking, woven fabric, vinyl, and paper.

5. A decorative article according to claim 1 wherein said backing sheet is selected from a group consisting of: paper and plastic.

6. A decorative article according to claim 1 wherein said graphics include at least one graphic element that appears as an extension of the outline of said decorative panel onto the exposed surface of said front sheet.

7. A decorative article according to claim 6 wherein said graphics include a plurality of graphic elements that each appears as an extension of different portions of the outline of said decorative panel onto the exposed surface of said front sheet.

8. A decorative article according to claim 1 wherein the first material is capable of accepting ink in a printing process.

9. A decorative article according to claim 1 wherein the selected decorative image is selected from a group consisting of: real animals, imaginary animals, cartoon characters, logos, celestial bodies, and symbols.

10. A kit adapted for use in decorating surfaces, comprising a plurality of separate decorative panels each correlated to a selected common decorative theme, each said decorative panel including a front sheet formed of a first material and a layer of tacky material secured to said front sheet, at least one of said decorative panels having a peripheral edge shaped to convey to an observer an outline of a selected decorative image corresponding to the common decorative theme with graphics disposed thereon that are correlated to the decorative image formed by the outline of said decorative panel and at least some of said decorative panels including graphics disposed thereon that are correlated to the common decorative theme, said tacky material having sufficient adhering capability to support the weight of said decorative panel when said decorative panel is placed on a vertically disposed support surface.

11. A kit according to claim 10 wherein a plurality of said decorative panels each have a peripheral edge shaped to convey to the observer an outline of a selected decorative image corresponding to the common decorative theme with graphics disposed thereon that are correlated to the decorative image formed by the outline of the respective said decorative panel.

12. A kit according to claim 10 wherein all of said decorative panels include graphics disposed thereon that are correlated to the common decorative theme.

13. A kit according to claim 10 wherein the tacky material is a thermal plastic elastomer.

14. A kit according to claim according to claim 13 wherein the thermal plastic elastomer is a micropore copolymer.

15. A kit according to claim according to claim 10 wherein each said front sheet is selected from a group consisting of: flocking, woven fabric, vinyl, and paper.

16. A kit according to claim 10 wherein the graphics on said at least one of said decorative panels includes at least one graphic element that appears as an extension of the outline of said decorative panel onto the exposed surface of the respective said front sheet.

17. A kit according to claim 10 wherein the selected decorative image is selected from a group consisting of: real animals, imaginary animals, cartoon characters, logos, celestial bodies, and symbols.

18. A kit adapted for use in decorating surfaces, comprising:
(A) a plurality of separate decorative panels each including a front sheet formed of a first material, said front sheet of each decorative panel having graphics disposed thereon that are operative to convey boundaries of portions of a respective decorative image to an observer with exposed areas demarked by said boundaries;
(B) a layer of tacky material secured to said front sheet;
(C) a plurality of markers of different colors, said markers each including a colored substance capable of being applied to said front sheets within the exposed areas so that a user may selectively color the exposed areas with such colored substances thereby to complete the respective decorative image; and
(D) a container sized and adapted to receive said plurality of decorative panels and said plurality of markers.

19. A method of decorating room having a wall with a wall surface, comprising;
(A) providing a plurality of separate decorative panels each correlated to a selected common decorative theme wherein each said decorative panel includes a front sheet formed of a first material and a layer of tacky material secured to said front sheet, at least one of said decorative panels having a peripheral edge shaped to convey to an observer an outline a selected decorative image corresponding to the common decorative theme with graphics disposed thereon that are correlated to the decorative image formed by the outline of said decorative panel and wherein at least some of said decorative panels including graphics disposed thereon that are correlated to the common decorative theme, said tacky material selected to have sufficient adhering capability to support the weight of the respective decorative panel when said decorative panel is placed on said wall yet being releasable from said wall without damaging the wall surface;
(B) adhering said decorative panels on said wall by means of said tacky material thereby to cover selected areas of said wall.
